(19) United States
(12) Patent Application Publication
(10) Pub. No.: US 2024/0403213 A1
(43) Pub. Date: Dec. 5, 2024

(54) CACHE METHOD AND APPARATUS APPLIED TO ALL-FLASH STORAGE, DEVICE, AND MEDIUM

(71) Applicant: SUZHOU METABRAIN INTELLIGENT TECHNOLOGY CO., LTD., Suzhou, Jiangsu (CN)

(72) Inventors: Zhikui LIU, Suzhou, Jiangsu (CN); Yanqing WANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/696,803

(22) PCT Filed: Dec. 23, 2022
(86) PCT No.: PCT/CN2022/141692

§ 371 Date: Mar. 28, 2024

(30) Foreign Application Priority Data
Jan. 24, 2022 (CN) 202210081049.9

(51) Int. Cl. G06F 12/0802; G06F 12/123

(52) U.S. Cl. CPC G06F 12/0802; G06F 12/123

(57) ABSTRACT

Embodiments of the present disclosure relate to a cache method and apparatus applied to all-flash storage, a device, and a medium. The method includes the following steps: acquiring and storing, by a multi-path node, write request information, and sending the write request information to storage nodes; generating, by the storage nodes, confirmation information corresponding to the write request information, and returning the confirmation information to the multi-path node; and determining the number of the confirmation information returned to the multi-path node, and in the case that the number of the confirmation information returned to the multi-path node is not less than one half of the number of the storage nodes, deleting the write request information stored to the multi-path node. According to the cache method and apparatus applied to the all flash storage, the device, and the medium in the embodiments of the present disclosure, in the case that data security is not reduced, the defect of write request delay caused by consistency of distributed cache can be greatly overcome, write request information write and read capabilities of an all flash disk array can be effectively improved, and overall performance of the cache apparatus applied to the all flash storage can be enhanced.

### CROSS-REFERENCE TO RELATED APPLICATION

The present application is a National Stage Application of PCT International Application No.: PCT/CN2022/141692 filed on Dec. 23, 2022, which claims priority to Chinese Patent Application 202210081049.9, filed in the China National Intellectual Property Administration on Jan. 24, 2022, the disclosure of which is incorporated herein by reference in its entirety.

### TECHNICAL FIELD

Embodiments of the present disclosure relate to the technical field of data cache, and particularly to a cache method and apparatus applied to all-flash storage, an electronic device, and a non-transitory computer readable storage medium.

### BACKGROUND

A current storage system is implemented based on strong consistency of distributed cache. An all-flash storage architecture and a flowchart of strong consistency of the distributed cache are shown in FIG. 1 and FIG. 2. Optionally, steps of consistent caching in the distributed cache are as follows: a host issues a write request to a node 1 in a storage cluster, the node 1 sends the write request to a node 2, and after writing the received write request to the cache, the node 2 notifies the node 1 of the successful write. After writing the write request to its own cache, the node 1 notifies the host of the successful write. After receiving the response about the successful write from the storage system, the host determines that the storage system has completed the dual-copy caching, that is, strong consistency of the distributed cache is implemented, and in this case, the host can continue to issue a new write request. Existing methods for achieving distributed cache strong consistency result in write request time delay of the host, have strict requirements for overall performance of the system in the data caching process, and increase the pressure on information read-write of an all-flash disk array.

### SUMMARY

In order to solve the above technical problems, embodiments of the present disclosure provide a cache method and apparatus applied to all-flash storage, an electronic device, and a non-transitory readable storage medium, which can effectively overcome the defect of write request delay caused by strong consistency of distributed cache, improve information write and read capabilities of the all-flash storage, and improve data read-write performance of the cache apparatus applied to the all-flash storage.

In order to achieve the above objectives, an embodiment of the present disclosure provides a first technical solution:

A cache method applied to all-flash storage includes the following steps: a multi-path node acquires and stores write request information, and sends the write request information to storage nodes, where the number of the storage nodes is at least 2; the storage nodes generate confirmation information corresponding to the write request information, and return the confirmation information to the multi-path node; and the number of the confirmation information returned to the multi-path node is determined, and in the case that the number of the confirmation information returned to the multi-path node is not less than one half of the number of the storage nodes, the write request information stored to the multi-path node is deleted.

In an embodiment of the present disclosure, the step that a multi-path node acquires and stores write request information includes: the multi-path node acquires the write request information and stores the write request information to a preset linked list; based on a data storage capacity of the linked list, whether a data volume of the write request information exceeds the data storage capacity of the linked list is determined; and in the case that the data volume of the write request information exceeds the data storage capacity of the linked list, the multi-path node stops sending the write request information to the storage node.

In an embodiment of the present disclosure, the step that the multi-path node sends the write request information to storage nodes further includes: the multi-path node sends the write request information to any one of the storage nodes one by one, and any one of the storage nodes stores the write request information to a doubly linked list corresponding to any one of the storage nodes.

In an embodiment of the present disclosure, the step that any one of the storage nodes stores the write request information to a doubly linked list corresponding to any one of the storage nodes includes: the write request information sent by the multi-path node to the storage nodes is stored according to a sequential order from a head of the doubly linked list to a tail of the doubly linked list.

In an embodiment of the present disclosure, the step that any one of the storage nodes stores the write request information to a doubly linked list corresponding to any one of the storage nodes further includes: the write request information stored to the doubly linked list is flushed, wherein the write request information stored to the doubly linked list is flushed includes: the data storage capacity of the linked list is obtained, and the data storage capacity of the linked list is defined as a first threshold; and based on the first threshold, the write request information stored to any one of the doubly linked lists is flushed according to a preset data flushing rule.

In an embodiment of the present disclosure, the preset data flushing rule includes: obtaining the number of the write request information stored to any one of the doubly linked lists, and determining, based on the first threshold, whether the number of the write request information stored to any one of the doubly linked lists is greater than the first threshold; and in the case that the number of the write request information stored to any one of the doubly linked lists is greater than the first threshold, flushing, according to the sequential order from the head of the doubly linked list to the tail of the doubly linked list, the write request information stored to the doubly linked list until the number of the write request information stored to the doubly linked list is not greater than the first threshold.

In an embodiment of the present disclosure, the method further includes: the multi-path node acquires and stores read request information one by one; and the multi-path node sends the read request information to any one of the storage nodes until any one of the storage nodes responds to the read request information.

In an embodiment of the present disclosure, the method further includes: when the multi-path node stops sending the write request information to the storage nodes, the multi-path node does not stop acquiring the write request information.

In an embodiment of the present disclosure, the step that the multi-path node does not stop acquiring the write request information includes: the multi-path node does not stop acquiring the write request information sent by a business application.

In an embodiment of the present disclosure, the step that the write request information sent by the multi-path node to the storage nodes is sequentially stored according to a sequential order from a head of the doubly linked list to a tail of the doubly linked list includes: the write request information first sent by the multi-path node to the storage node is taken as old data to be stored at the head of the doubly linked list, and the write request information subsequently sent by the multi-path node to the storage node is taken as new data to be stored at the tail of the doubly linked list.

In an embodiment of the present disclosure, each of the storage nodes is configured to only send a piece of confirmation information to the multi-path node after successfully writing the write request information sent by the multi-path node to the doubly linked list set corresponding to the storage node.

In an embodiment of the present disclosure, the confirmation information includes node identifiers of the storage nodes.

In an embodiment of the present disclosure, after the confirmation information is returned to the multi-path node, the method further includes: the multi-path node confirms, based on the confirmation information returned by the storage node, the node identifier in the confirmation information so as to ensure that the number of the confirmation information sent by the storage node to the multi-path node is one.

In an embodiment of the present disclosure, the step that the number of the confirmation information returned to the multi-path node is determined includes: the number of the confirmation information returned to the multi-path node is determined in the case that the number of the confirmation information sent by the storage node to the multi-path node is one.

In an embodiment of the present disclosure, a plurality of the storage nodes form a storage unit configured to store the write request information, and a plurality of doubly linked lists which are in one-to-one correspondence with any one of the storage nodes are set.

In an embodiment of the present disclosure, the flushed write request information is write request information that has already been stored in any one of the storage nodes.

In an embodiment of the present disclosure, the flushed write request information is write request information that has achieved cache consistency in any one of the storage nodes.

In order to achieve the above objectives, an embodiment of the present disclosure further provides a second technical solution:

A cache apparatus applied to all-flash storage includes: an information acquisition unit, where the information acquisition unit is configured for a multi-path node to acquire and store write request information and send the write request information to storage nodes, and the number of the storage nodes is at least 2; an information return unit, where the information return unit is in communication connection with the information acquisition unit, the storage nodes generate confirmation information corresponding to the write request information, and the information return unit is configured to return the confirmation information to the multi-path node; and an information discrimination unit, where the information discrimination unit is in communication connection with the information return unit, and is configured to determine the number of the confirmation information returned to the multi-path node, and in the case that the number of the confirmation information returned to the multi-path node is not less than one half of the number of the storage nodes, the write request information stored to the multi-path node is deleted.

In an embodiment of the present disclosure, an electronic device is further provided, and includes a processor and a memory. When the processor executes a computer program stored in the memory, the computer program is set to perform the steps in any one of the above method embodiments during operation.

In an embodiment of the present disclosure, a computer non-transitory readable storage medium is further provided, and configured to store a computer program. When executed by a processor, the computer program are configured to cause the computer to perform the steps in any one of the above method embodiments.

Compared with the prior art, the technical solutions in the embodiments of the present disclosure have the following advantages:

According to the cache method and apparatus applied to the all-flash storage, the electronic device, and the non-transitory readable storage medium in the embodiments of the present disclosure, the method includes: the multi-path node acquires and stores the write request information, and sends the write request information to the storage nodes, where the number of the storage nodes is at least 2; the storage nodes generate the confirmation information corresponding to the write request information, and return the confirmation information to the multi-path node; and the number of the confirmation information returned to the multi-path node is determined, and in the case that the number of the confirmation information returned to the multi-path node is not less than one half of the number of the storage nodes, the write request information stored to the multi-path node is deleted. According to the cache method and apparatus applied to the all-flash storage, the electronic device, and the non-transitory readable storage medium in the embodiments of the present disclosure, in the case that data security is not reduced, the defect of write request delay caused by strong consistency of the distributed cache can be greatly overcome, request information write and read capabilities of an all-flash disk array can be effectively improved, and data information read-write performance of the cache apparatus applied to the all-flash storage can be enhanced.

### BRIEF DESCRIPTION OF THE DRAWINGS

In order to describe technical solutions in embodiments of the present disclosure more clearly, accompanying drawings required to be used in descriptions of the embodiments will be briefly introduced below, it is apparent that the accompanying drawings described below are only some embodiments of the present disclosure, and those of ordinary skill in the art can obtain other accompanying drawings according to these accompanying drawings without creative work.

FIG. 1 is a structural schematic diagram of an all-flash storage architecture in the prior art;

FIG. 2 is a flowchart of strong consistency of distributed cache in the prior art;

FIG. 3 is a flowchart of a method according to an embodiment of the present disclosure;

FIG. 4 is a flowchart of acquiring and issuing write request information according to an embodiment of the present disclosure;

FIG. 5 is a schematic diagram of data flushing according to an embodiment of the present disclosure;

FIG. 6 is a structural diagram of an apparatus according to an embodiment of the present disclosure.

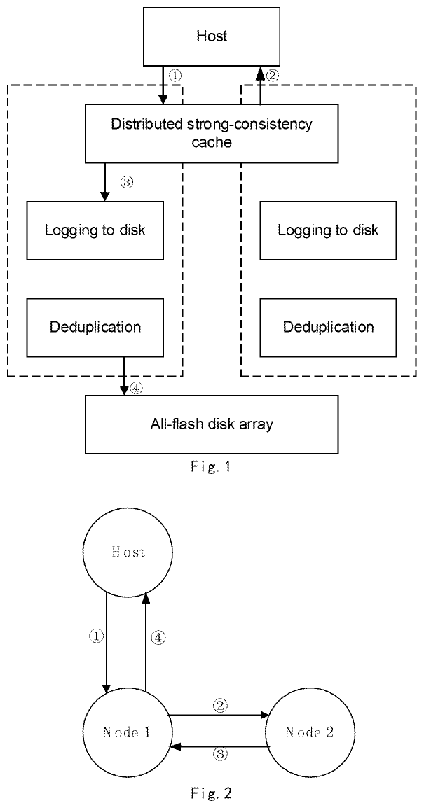

### DETAILED DESCRIPTION OF THE EMBODIMENTS

To make objectives, technical solutions, and advantages of embodiments of the present disclosure more clear, the technical solutions in the embodiments of the present disclosure are clearly and completely described in conjunction with the accompanying drawings in the embodiments of the present disclosure as below, and it is apparent that the described embodiments are only a part rather all of embodiments of the present disclosure. Based on the embodiments of the present disclosure, all other embodiments obtained by those of ordinary skill in the art without creative labor shall fall within the scope of protection of the present disclosure.

### Embodiment 1

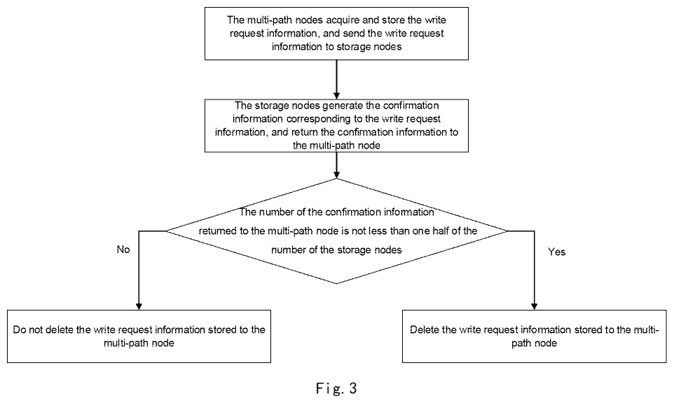

Referring to FIG. 3, FIG. 3 is a flowchart of a method according to Embodiment 1.

The method in this embodiment includes the following steps:

Step S1: A multi-path node acquires and stores write request information, and sends the write request information to storage nodes, where the number of the storage nodes is at least 2.

Step S2: The storage nodes generate confirmation information corresponding to the write request information, and return the confirmation information to the multi-path node.

Step S3: The number of the confirmation information returned to the multi-path node is determined, and in the case that the number of the confirmation information returned to the multi-path node is not less than one half of the number of the storage nodes, the write request information stored to the multi-path node is deleted. It should be understood that in this embodiment of the present disclosure, the number of the confirmation information returned to the multi-path node is an integer not less than one half of the number of the storage nodes. For example, when the number of the storage nodes is 5, the write request information stored to the multi-path node is deleted as long as the number of the confirmation information returned to the multi-path node is greater than 3.

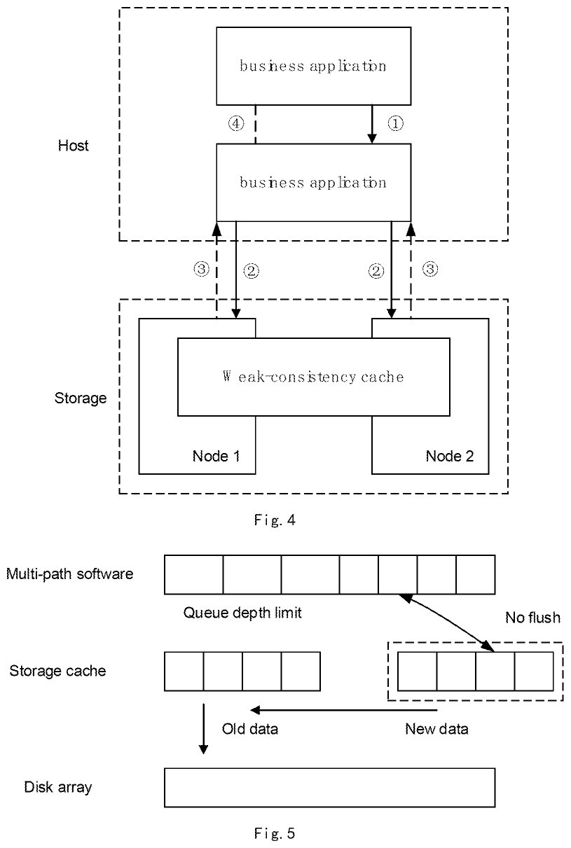

In an embodiment, the step that a multi-path node acquires and stores write request information includes: the multi-path node acquires the write request information and stores the write request information to a preset linked list; based on a data storage capacity of the linked list, whether a data volume of the write request information exceeds the data storage capacity of the linked list is determined; and in the case that the data volume of the write request information exceeds the data storage capacity of the linked list, the multi-path node stops sending the write request information to the storage node. It should be understood that when the data volume of the write request information exceeds the data storage capacity of the linked list, the multi-path node can stop sending the write request information to the storage node without the stop of acquisition of the write request information. According to a flowchart of write request information acquisition and dispatch shown in FIG. 4, a business application sends the write request information to the multi-path node, that is, the multi-path node acquires the write request information. When the data volume of the write request information exceeds the data storage capacity of the linked list, the multi-path node stops issuing the write request information to the storage node without the stop of acquisition of the write request information sent by the business application. Those skilled in the art can set a detailed operation state of the multi-path node according to actual situations.

In an embodiment, the step that the multi-path node sends the write request information to storage nodes further includes: the multi-path node sends the write request information to any one of the storage nodes one by one, and any one of the storage nodes stores the write request information to a doubly linked list corresponding to any one of the storage nodes. That is, there are a plurality of storage nodes forming a storage unit configured to store the write request information. A plurality of doubly linked lists which are in one-to-one correspondence with any one of the storage nodes are further set. It should be understood that data stored in any one of the doubly linked lists may include but not limited to the write request information. Those skilled in the art can reasonably select, according to actual situations, the type of data stored in the doubly linked list.

In an embodiment, the step that any one of the storage nodes stores the write request information to a doubly linked list corresponding to any one of the storage nodes includes: the write request information sent by the multi-path node to the storage nodes is stored according to a sequential order from a head of the doubly linked list to a tail of the doubly linked list. That is, the sequential order of the write request information sent by the multi-path node to any one of the storage nodes is determined, the write request information first sent by the multi-path node to any one of the storage nodes is taken as old data to be stored at the head of the doubly linked list, and the write request information subsequently sent by the multi-path node to any one of the storage nodes is taken as new data to be stored at the tail of the doubly linked list. The corresponding doubly linked list is set in correspondence to any one of the storage nodes, so as to implement a Least Recently Used (LRU) algorithm.

In an embodiment, the step that any one of the storage nodes stores the write request information to a doubly linked list corresponding to any one of the storage nodes further includes: the write request information stored to the doubly linked list is flushed. The step that the write request information stored to the doubly linked list is flushed includes: the data storage capacity of the linked list is obtained, and the data storage capacity of the linked list is defined as a first threshold; and based on the first threshold, the write request information stored to any one of the doubly linked lists is flushed according to a preset data flushing rule. FIG. 5 is a schematic diagram of data flushing for write request information. Flushing the write request information may be understood as, but is not limited to, writing the write request information written to the cache to a disk. As an optional example, one of the functions of the cache is to provide a write-back capability. In other words, after a user writes the write request information to the cache, that is, a response is made to the successful write by the user, in this case, the write request information (or referred to as write data) exists only in the cache, and not on the disk. The aforementioned flushing refers to writing the write request information from the cache to the disk.

In an embodiment, the preset data flushing rule includes: obtaining the number of the write request information stored to any one of the doubly linked lists, and determining, based on the first threshold, whether the number of the write request information stored to any one of the doubly linked lists is greater than the first threshold; and in the case that the number of the write request information stored to any one of the doubly linked lists is greater than the first threshold, flushing, according to the sequential order from the head of the doubly linked list to the tail of the doubly linked list, the write request information stored to the doubly linked list until the number of the write request information stored to the doubly linked list is not greater than the first threshold. Accordingly, it is ensured that the flushed write request information is not the write request information stored in the linked list. In other words, the flushed write request information is the write request information that has already been stored in any one of the storage nodes, meaning that the flushed write request information is write request information that has achieved cache consistency in any one of the storage nodes.

In an embodiment, when the number of the storage nodes is 2, the 2 storage nodes are set as a storage node 1 and a storage node 2 respectively. The multi-path node sends the write request information acquired from the host to the storage node 1 and the storage node 2 respectively. After receiving the write request information sent by the multi-path node, the storage node 1 and the storage node 2 store the received write request information to the correspondingly set doubly linked lists, and the storage node 1 and the storage node 2 return confirmation information to the multi-path node. It should be understood in the case that the storage node 1 returns the confirmation information to the multi-path node, it means that the write request information issued by the multi-path node has been successfully written by the storage node 1. The number of the confirmation information returned to the multi-path node is not affected by the number of the storage nodes. In other words, although the multi-path node has sent the write request information to the storage node 1 and the storage node 2, it is possible that the storage node 1 or the storage node 2 returns the confirmation information to the multi-path node, and it is also possible that neither the storage node 1 nor the storage node 2 returns the confirmation information to the multi-path node. When the number of the storage nodes is 2, the corresponding write request information stored to the multi-path node is deleted as long as the number of the confirmation information returned to the multi-path node exceeds one half of the number of the storage nodes, that is, the number of the confirmation information returned to the multi-path node is not less than 1.

In an embodiment, when the number of the storage nodes is 5, the 5 storage nodes are respectively set as a storage node 1, a storage node 2, a storage node 3, a storage node 4, and a storage node 5. The multi-path node issues the acquired write request information to the above 5 storage nodes and meanwhile stores the write request information to the correspondingly set linked lists. After the storage nodes receive the write request information sent by the multi-path node and successfully write the write request information sent by the multi-path node to the correspondingly set doubly linked lists, the confirmation information will be sent to the multi-path node. It should be understood that after each storage node successfully writes the write request information sent by the multi-path node to the correspondingly set doubly linked list, each storage node will only send a piece of confirmation information to the multi-path node. After the number of the confirmation information received by the multi-path node exceeds 3, the write request information stored to the linked lists set corresponding to the multi-path node is deleted.

In an embodiment, the confirmation information includes node identifiers of the storage nodes. Optionally, the multi-path node confirms, based on the confirmation information returned by any one of the storage nodes, the node identifier in the confirmation information so as to ensure that the number of the confirmation information sent by any one of the storage nodes to the multi-path node is one, thereby preventing the same storage node from sending a plurality of pieces of confirmation information to the multi-path node. For example, when the number of the storage nodes is 2, for ease of distinction, those skilled in the art can set the above two storage nodes as the storage node 1 and the storage node 2. Correspondingly, the node identifier of the storage node 1 may be the node identifier 1, and the node identifier of the storage node 2 may be the node identifier 2. It should be understood that the form and name of the node identifiers of the storage nodes are not limited, which can be determined by those skilled in the art according to actual situations, ensuring only that the identification of the storage nodes can be achieved based on the node identifiers.

In an embodiment, the method further includes: the multi-path node acquires and stores read request information one by one; and the multi-path node sends the read request information to any one of the storage nodes until any one of the storage nodes responds to the read request information.

It should be understood that although the steps in the flowchart of FIG. 3 are shown sequentially according to the direction of arrows, these steps are not necessarily performed in an order indicated by the arrows. Unless explicitly stated in this specification, there are no strict sequential limitations on the execution of these steps, and these steps may be executed in a different order. Moreover, at least some of the steps in FIG. 3 may include a plurality of substeps or a plurality of stages. These substeps or stages may not be necessarily completed at the same time but may be performed at different times. These substeps or stages are not necessarily performed in sequence, but may be performed in a rotation or alternation manner with other steps or at least some of the substeps or stages in other steps.

### Embodiment 2

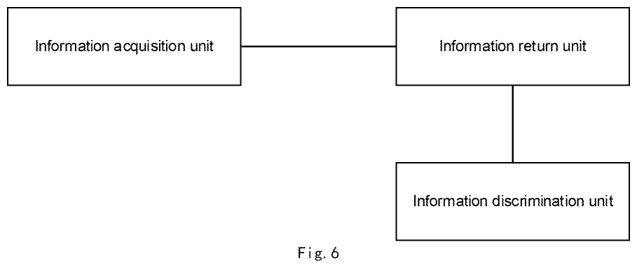

Referring to FIG. 6, FIG. 6 is a structural diagram of a cache apparatus applied to all-flash storage according to Embodiment 2.

The cache apparatus applied to the all-flash storage in this embodiment includes: an information acquisition unit, where the information acquisition unit is configured for a multi-path node to acquire and store write request information and send the write request information to storage nodes, and the number of the storage nodes is at least 2; an information return unit, where the information return unit is in communication connection with the information acquisition unit, the storage nodes generate confirmation information corresponding to the write request information, and the information return unit is configured to return the confirmation information to the multi-path node; and an information discrimination unit, where the information discrimination unit is in communication connection with the information return unit, and is configured to determine the number of the confirmation information returned to the multi-path node, and in the case that the number of the confirmation information returned to the multi-path node is not less than one half of the number of the storage nodes, the write request information stored to the multi-path node is deleted.

In an embodiment, the information acquisition unit includes: an information storage module. The information storage module is configured to store the write request information acquired by the multi-path node to a preset linked list, and store the write request information acquired by any one of the storage nodes to a doubly linked list set corresponding to any one of the storage nodes.

In an embodiment, the apparatus further includes: an information flushing unit. The information flushing unit is in communication connection with the information acquisition unit, and the information flushing unit flushes, based on a data storage capacity of the linked list, the write request information stored to any one of the doubly linked lists according to a preset data flushing rule.

In an embodiment, the apparatus further includes: an information alarm unit. The information alarm unit is in communication connection with the information acquisition unit, and is configured to display a notification about a state that the data volume of the write request information exceeds the data storage capacity of the linked list. That is, in the case that the data volume of the write request information exceeds the data storage capacity of the linked list, the information alarm unit gives an alarm, configured to notify the multi-path node to stop sending the write request information to the storage nodes.

For limitations on the cache apparatus applied to the all-flash storage, reference may be made to the limitations on the cache method applied to the all-flash storage above, which are not repeated herein. Various modules in the cache apparatus applied to the all-flash storage may be all or partly implemented by software, hardware, and a combination thereof. The above various modules may be embedded in or independent of a processor in a computer device in a hardware form, and may also be stored in a memory of the computer device in a software form, such that the processor can call and execute operations corresponding to the various modules.

### Embodiment 3

An embodiment provides a computer non-transitory readable storage medium. The computer non-transitory readable storage medium stores a program. When the program is executed by the processor, the processor performs the steps of the cache method applied to the all-flash storage according to Embodiment 1.

Those skilled in the art should understand that the embodiments from the embodiments of the present disclosure may be provided as a method, an apparatus, or a computer program product. Therefore, the embodiments of the present disclosure may adopt a form of complete hardware embodiments, complete software embodiments, or embodiments combining software and hardware. In addition, in the embodiments of the present disclosure, a form of a computer program product implemented on one or more computer available non-transitory readable storage media (including but not limited to disk storage, a CD-ROM, optical storage, etc.) including computer available program code.

In the embodiments of the present disclosure, the description is made with reference to the flowcharts and/or block diagrams of the method, the device (apparatus), and the computer program product in the embodiments from the embodiments of the present disclosure. It should be understood that computer program instructions can implement each process and/or block in the flowcharts and/or the block diagrams, and a combination of processes and/or blocks in the flowcharts and/or block diagrams. These computer program instructions can be provided to a general-purpose computer, a special-purpose computer, an embedded processor, or a processor of another programmable data processing device to generate a machine, so that an apparatus configured to implement functions specified in one or more processes in the flowcharts and/or one or more blocks in the block diagrams is generated by using instructions executed by the computer or the processor of the another programmable data processing device.

These computer program instructions may alternatively be stored in a computer-readable memory that can instruct a computer or another programmable data processing device to work in a specific manner, so that the instructions stored in the computer-readable memory generate a product that includes an instruction apparatus. The instruction apparatus implements a function specified in one or more processes in the flowcharts and/or in one or more blocks in the block diagrams.

These computer program instructions may also be loaded onto the computer or the another programmable data processing device, so that a series of operation steps are performed on the computer or the another programmable device, thereby generating computer-implemented processing. Therefore, the instructions executed on the computer or the another programmable device provide steps for implementing functions specified in one or more processes in the flowcharts and/or in one or more blocks in the block diagrams.

It should be noted that the above is only optional embodiments and applied technical principles of the present disclosure. Those skilled in the art can understand that the embodiments of the present disclosure are not limited to the specific embodiments described herein, and those skilled in the art can make various apparent changes, modifications, and substitutions without departing from the scope of protection of the embodiments of the present disclosure. Therefore, although the embodiments of the present disclosure have been described in detail in the above embodiments, the embodiments of the present disclosure are not limited to the above embodiments. Without departing from the conception of the embodiments of the present disclosure, various other equivalent embodiments may also be included while the scope of the embodiments of the present disclosure is determined by the appended claims.

1. A cache method applied to all-flash storage, wherein the method comprises:
acquiring and storing, by a multi-path node, write request information, and sending the write request information to storage nodes, a number of the storage nodes being at least 2;
generating, by the storage nodes, confirmation information corresponding to the write request information, and returning the confirmation information to the multi-path node; and
determining a number of the confirmation information returned to the multi-path node, and in a case that the number of the confirmation information returned to the multi-path node is not less than one half of the number of the storage nodes, deleting the write request information stored to the multi-path node.

2. The cache method applied to the all-flash storage according to claim 1, wherein the acquiring and storing, by a multi-path node, write request information comprises:
acquiring, by the multi-path node, the write request information, and storing the write request information to a preset linked list;
determining, based on a data storage capacity of the linked list, whether a data volume of the write request information exceeds the data storage capacity of the linked list; and
stopping, by the multi-path node, sending the write request information to the storage node in a case that the data volume of the write request information exceeds the data storage capacity of the linked list.

3. The cache method applied to the all-flash storage according to claim 2, wherein the sending, by a multi-path node, the write request information to storage nodes further comprises:
sending, by the multi-path node, the write request information to any one of the storage nodes one by one, and storing, by any one of the storage nodes, the write request information to a doubly linked list set corresponding to any one of the storage nodes.

4. The cache method applied to the all-flash storage according to claim 3, wherein the storing, by any one of the storage nodes, the write request information to a doubly linked list set corresponding to any one of the storage nodes comprises:
storing the write request information sent by the multi-path node to the storage nodes according to a sequential order from a head of the doubly linked list to a tail of the doubly linked list.

5. The cache method applied to the all-flash storage according to claim 4, wherein the storing, by any one of the storage nodes, the write request information to a doubly linked list set corresponding to any one of the storage nodes further comprises: flushing the write request information stored to the doubly linked list;
wherein the flushing the write request information stored to the doubly linked list comprises:
obtaining a data storage capacity of a linked list, and defining the data storage capacity of the linked list as a first threshold; and
flushing, based on the first threshold, the write request information stored to any one of the doubly linked lists according to a preset data flushing rule.

6. The cache method applied to the all-flash storage according to claim 5, wherein the preset data flushing rule comprises:
obtaining a number of the write request information stored to any one of the doubly linked lists, and determining, based on the first threshold, whether the number of the write request information stored to any one of the doubly linked lists is greater than the first threshold; and
in a case that the number of the write request information stored to any one of the doubly linked lists is greater than the first threshold, flushing, according to the sequential order from the head of the doubly linked list to the tail of the doubly linked list, the write request information stored to the doubly linked list until the number of the write request information stored to the doubly linked list is not greater than the first threshold.

7. The cache method applied to the all-flash storage according to claim 5, wherein the method further comprises:
acquiring and storing, by the multi-path node, read request information one by one; and
sending, by the multi-path node, the read request information to any one of the storage nodes until any one of the storage nodes responds to the read request information.

8. The cache method applied to the all-flash storage according to claim 2, wherein the method further comprises:
when the multi-path node stops sending the write request information to the storage nodes, continuing to acquire the write request information by the multi-path node.

9. The cache method applied to the all-flash storage according to claim 8, wherein the continuing to acquire the write request information by the multi-path node comprises:
continuing to acquire, by the multi-path node, the write request information sent by a business application.

10. The cache method applied to the all-flash storage according to claim 4, wherein the sequentially storing the write request information sent by the multi-path node to the storage nodes according to a sequential order from a head of the doubly linked list to a tail of the doubly linked list comprises:
taking the write request information first sent by the multi-path node to the storage node as old data to be stored at the head of the doubly linked list, and taking the write request information subsequently sent by the multi-path node to the storage node as new data to be stored at the tail of the doubly linked list.

11. The cache method applied to the all-flash storage according to claim 1, wherein each of the storage nodes is configured to only send a piece of confirmation information to the multi-path node after successfully writing the write request information sent by the multi-path node to the doubly linked list set corresponding to the storage node.

12. The cache method applied to the all-flash storage according to claim 1, wherein the confirmation information comprises node identifiers of the storage nodes.

13. The cache method applied to the all-flash storage according to claim 12, wherein after the confirmation information is returned to the multi-path node, the method further comprises:
confirming, by the multi-path node, the node identifier in the confirmation information based on the confirmation information returned by the storage node so as to ensure that the number of the confirmation information sent by the storage node to the multi-path node is one.

14. The cache method applied to the all-flash storage according to claim 13, wherein the determining the number of the confirmation information returned to the multi-path node comprises:
determining the number of the confirmation information returned to the multi-path node in a case that the number of the confirmation information sent by the storage node to the multi-path node is one.

15. The cache method applied to the all-flash storage according to claim 3, wherein a plurality of the storage nodes form a storage unit configured to store the write request information, and a plurality of doubly linked lists which are in one-to-one correspondence with any one of the storage nodes are set.

16. The cache method applied to the all-flash storage according to claim 6, wherein the flushed write request information is write request information that has already been stored in any one of the storage nodes.

17. The cache method applied to the all-flash storage according to claim 6, wherein the flushed write request information is write request information that has achieved cache consistency in any one of the storage nodes.

18. (canceled)

19. An electronic device, comprising a processor and a memory, the memory is configured to store computer program, the processor is configured to execute the computer program to:
acquire and store, by a multi-path node, write request information, and send the write request information to storage nodes, the number of the storage nodes being at least 2;
generate, by the storage nodes, confirmation information corresponding to the write request information, and return the confirmation information to the multi-path node; and
determine the number of the confirmation information returned to the multi-path node, and in a case that the number of the confirmation information returned to the multi-path node is not less than one half of the number of the storage nodes, delete the write request information stored to the multi-path node.

20. A non-transitory computer readable storage medium, configured to store a computer program, when executed by a processor, the computer program is configured to cause the processor to:
acquire and store, by a multi-path node, write request information, and send the write request information to storage nodes, the number of the storage nodes being at least 2;
generate, by the storage nodes, confirmation information corresponding to the write request information, and return the confirmation information to the multi-path node; and
determine the number of the confirmation information returned to the multi-path node, and in a case that the number of the confirmation information returned to the multi-path node is not less than one half of the number of the storage nodes, delete the write request information stored to the multi-path node.

21. The cache method applied to the all-flash storage according to claim 5, wherein flushing the write request information comprises:
writing the write request information written to the cache to a disk.
